(19) United States
(12) Patent Application Publication
(10) Pub. No.: US 2020/0141648 A1
(43) Pub. Date: May 7, 2020

(54) Device and Method for Drying or Heating and Cooling Bulk Material

(71) Applicant: Allgaier Werke GmbH, Uhingen (DE)

(72) Inventors: Mathias Trojosky, Kirchheim unter Teck (DE); Gerd Stolzner, Alfdorf (DE); Christoph Fill, Schelklingen (DE)

(21) Appl. No.: 16/338,879

(22) PCT Filed: Sep. 12, 2017
(86) PCT No.: PCT/EP2017/001080

§ 371 Date: Apr. 2, 2019

(30) Foreign Application Priority Data
Oct. 4, 2016 (DE) 10 2016 011 907.1

(51) Int. Cl. F27B 7/02; F27B 7/10; F27B 7/12; F26B 11/02; F26B 11/04

(52) U.S. Cl. CPC F27B 7/02; F27B 7/10; F27B 2007/025; F26B 11/028; F26B 11/0436; F27B 7/12

(57) ABSTRACT

The device for drying or heating and cooling bulk material in accordance with the invention consists of a rotatable drum comprising means for receiving the bulk material in a first region and means for discharging the bulk material from a second region, wherein a central region is arranged between the first and second regions, said central region consisting of an annular structure with a first and a second diaphragm with central diaphragm apertures each, which form substantially two diaphragm planes parallel to each other, and comprise a plurality of transport channels closed toward the central region for transporting the bulk material from the first region to the second region of the rotatable drum through the central region, wherein the transport channels extend from the first to the second diaphragms at a non-90° angle relative to the two diaphragm planes.

The subject matter of the present invention is a device and a method for drying or heating and cooling bulk material.

In various industrial fields, such as especially in metallurgy, chemical industry, construction material and cement industry as well as recycling industry, plants for drying most diverse products such as sands, slags, clays, bentonite, limestone granulate, etc. are required.

The different products as a rule assume temperatures between e.g. 70° C. and 160° C. after drying. Without cooling the products which are hot after drying, further process 15 control is often not possible. Depending on the specific requirements of process technology and especially the subsequent aggregates and process steps, differently high solid matter temperatures of the dried and cooled solid matter can be accepted.

These desired temperatures range, for instance, with sands in the region of 55° C. to a maximum of 65° C. or else from 30° C. to a maximum of 45° C. in the case of particularly demanding applications, and/or e.g. approx. 10 K to a maximum of 15 K above the respective ambient temperature.

Various technologies for cooling or for the combined drying and cooling of such bulk material exist, wherein, for the above-mentioned objects, predominantly drum dryers (also called rotary dryers) and turboflow dryers (also called fluidized bed dryers) are used.

A combined drying and cooling drum with the designation System MOZER TK and TK+ of the company Allgaier is known. In these systems it is achieved, by a so-called two-way (i.e. double-shell) construction consisting of two tubes fitted into each other, that the dried material which has assumed an increased temperature of e.g. 70° C. to 160° C. due to drying, is cooled after drying immediately and in the same apparatus.

While in the system TK cooling is achieved by contacting the dried, hot or warm solid matter with sucked cool ambient air, cooling in the system TK+ is achieved by mixing a particular amount of moist solid matter with the dried, hot solid matter and by an evaporative cooling caused thereby.

While the system TK+ stands out by particular energy efficiency, both systems can, due to their two-shell construction, only achieve in a restricted manner low solid matter temperatures of e.g. 50° C. to approx. 70° C. depending on the ambient temperature and on the temperature of the solid matter directly after drying.

The reason for the restricted cooling performance is that the dried solid matter is guided in the outer shell of the two-way drum dryer for cooling. While the cooling of the dried, warm solid matter is achieved here by the contact with the ambient air, it is of counteractive significance for the cooling process that the inner tube of the dryer-cooler which is used for drying the moist solid matter and which is therefore hot is in contact with the solid matter to be cooled and thus counteracts the cooling to particularly low temperatures (e.g. only approx. 10 K above the ambient temperature). A certain disadvantage of the two-shell construction described consists in that the installations for solid matter transport in the outer drum (i.e. the installations between the outer and the inner drums) are quite difficult to access and that an exchange of the installations which are e.g. worn by the treatment of strongly abrasive solid matter and/or a maintenance thereof is aggravated. Moreover, due to the two-shell construction the length ratio between the inner and the outer drums is largely predetermined, so that the flexibility of the process between drying and cooling is restricted.

Although the described technology of two-shell drum dryers/coolers is used in many cases in operational practice and the achieved solid matter temperatures are often sufficient for the further processes, there is still increasing demand of achieving particularly low temperatures of the products after drying and cooling.

This has, e.g. in the field of the drying of sands for the production of ready-mix construction materials such as finished mortars, plastering and tile adhesive, its reason in the increased use of temperature-sensitive additives which are, directly after the drying of the sands, mixed therein pursuant to respective recipes. A similar demand of particularly low sand temperatures (e.g. 30° C. to 40° C.) exists in the field of the production or preparation of molding sand.

Moreover, it may be necessary to achieve particularly low solid matter temperatures if the dried solid matter is intended to be packed e.g. in packages of temperature-sensitive plastic materials, such as e.g. plastic bags, directly after drying and cooling. In order to satisfy the described demand of particularly low solid matter temperatures after drying, combined fluidized bed dryers/coolers are for example used in different fields of industry. Such fluidized bed dryers consist of two successively arranged regions which effect the required cooling after drying. For cooling, ambient air is also used as a rule.

It is generally known that fluidized bed dryers/coolers can, despite their good function on principle, not establish themselves without restriction especially in the fields of mineral material industry, mining, recycling. Applicants in the fields mentioned prefer in many cases the drum dryers which are known to be especially robust and fault-tolerant.

This is because drum dryers are capable of mastering especially well the problems occurring particularly frequently in the mentioned fields of mineral material industry, mining recycling, namely e.g. fluctuating production amounts, fluctuating product entry moistures, varying grain sizes of the products, particularly severe ambient conditions, possibly low qualification of the operating personnel, very simple system controls, etc.

Another possibility of cooling the hot solid matter existing after drying consists in the use of heat exchangers operated with cooling water (so-called bulk flow heat exchangers). These heat exchangers have the disadvantage that the providing of cooling water is necessary for their operation. Moreover, it happens that, in the case of solid matter which has not been dried completely, condensation phenomena of the residual moisture being in the solid matter occur on the heat exchanger faces cooled by the cooling water. As a consequence, adhering to the heat exchanger faces moistened by the condensation and subsequently blocking of the heat exchangers used may take place.

In order to achieve the frequently desired low temperatures of the dried solid matter after the cooling thereof by means of drum dryers, various technical solutions and modifications of simple drum dryers are known.

Thus, for instance, two separate apparatus are used, namely a first drying drum and a downstream, separate second cooling drum, wherein the dried solid matter either flows directly from the drying drum into the cooling drum by the drying drum being positioned higher than the cooling drum and a simple connection between the dryer outlet and the cooler inlet, e.g. in the form of a chute, being implemented.

Alternatively, conveyor aggregates (e.g. a bucket conveyor or a conveyor belt) may be used for transporting the hot, dried solid matter from the dryer outlet and for filling same into the cooling drum.

For a good efficiency of the cooling a so-called counterflow of solid matter and cooling air is often used. The cooling air is then guided contrary to the conveying direction of the solid matter through the cooling drum. Thus, the necessary amount of cooling air is minimized and usually a temperature of the cooled solid matter just above the temperature of the entering cooling air (i.e. often the ambient air) is achieved.

U.S. Pat. No. 3,599,346 further discloses a technical solution of a combined drying-cooling drum in which the drying drum is designed with a smaller diameter than the cooling drum, whereby it is achieved that the exit end of the drying drum projects into the cooling drum with a certain necessary length of itself. Thus, it is achieved that the dried and hot solid matter is directly surrendered to the cooling drum.

In this embodiment the above-described energetically efficient counterflow between the solid matter and the cooling air can be advantageously implemented during cooling. However, a rather complex connection of the two separate drums is necessary for drying, on the one hand, and for cooling, on the other hand, said connection enabling that both the consumed drying air and the consumed cooling air can be sucked off at the connection point of the two drums.

While it is desired, on the one hand, that the diameter of the drying drum is as large as possible for achieving an optimum performance, it is desired, on the other hand, that the ring gap remaining between the drying drum of smaller diameter and the cooling drum of larger diameter is sufficiently large to suck off the drying exhaust air and the cooling exhaust air which are to be sucked off at this position in such a manner that as little as possible of the solid matter to be treated gets into the exhaust stream, i.e. is entrained by the sum of the two exhaust streams from the dryer and from the cooler. Since this entrained solid matter amount depends on the velocity of the air in the gap between the inner drying drum and the outer cooling drum, both objects contradict each other.

U.S. Pat. No. 2,309,810 discloses a device for a combined drying and cooling in a likewise two-shell drying and cooling drum in which the drying drum of smaller diameter is, similar to the System MOZER TK+, mounted in a cooling drum of larger diameter.

The inner drum serving for drying is shorter than the outer drum and ends approximately at half the length of the outer drum. The solution described there uses the mixing of the dried hot solid matter in a flow of solid matter which has not dried yet, whereafter both solid matter amounts jointly finish drying in the outer drum.

A further technical solution of a combined drying and cooling drum is described in U.S. Pat. No. 9,322,595 B1 in which the drying and cooling of sands is performed in a one-way drum, i.e. in a continuous tube of the same diameter. This solution also comes close to the basic idea of the System MOZER TK+ in that, for cooling the dried sand, a certain amount of moist sand is given in a first drum section and is mixed into the dried, hot solid matter stream. Thus, evaporative cooling of hot sand that has already dried ensues with a simultaneous drying of the added share of sand which is still moist. This technical solution requires a quite complicated component or mechanism for introducing the share of moist sand after the drying zone without solid matter in the region of the adding of the moist matter falls out of the drum. This component or mechanism is described in the patent document.

Moreover, the proposed solution has the disadvantage that the cooling is not performed in the counterflow with fresh, cool ambient air, but that the entire solid matter of material that is already dry and of added moist material contacts the consumed dryer exhaust air and is guided in the coflow to the exit end of the dryer/cooler. Thus, the entire solid matter to be dried and cooled is in contact in the coflow with the drying air carrying the evaporated water amount. Despite the use of the principle of evaporative cooling, little efficiency of the entire system of drying and cooling consequently has to be expected.

DE 3134084 A1 describes a method, although modified, which is often used in sugar industry and in which the solid matter is guided in the counterflow to the drying and cooling air through a drum dryer-cooler. In the drying zone, drying is performed with a mixture of hot air which is guided via a separate tube that is arranged centrically in the dryer and is guided approximately to the middle of the dryer, and of the pre-heated cooling air coming from the cooling zone. Cooling takes place in the region of the dryer/cooler in which the hot drying air has not yet been mixed into the cooling air stream.

It is thus a technical object of the invention to eliminate the deficiencies of the known technical solutions by a suitable constructional design and to improve the function and efficiency of the dryer/cooler by an improved conduction of the flow of the solid matter and the drying and cooling air, as well as to reduce the manufacturing costs for the cooler by reducing the amount of work in production (especially for the welding and installation work).

This object is solved by the device in accordance with the invention and by the method in accordance with the invention with the features according to claim 1 and/or claim 11. Advantageous further developments of the present invention are characterized in the dependent claims.

The device for drying or heating and cooling bulk material in accordance with the invention consists of a rotatable drum comprising means for receiving the bulk material in a first region and means for discharging the bulk material from a second region, wherein a central region is arranged between the first and second regions, said central region consisting of an annular structure with a first and a second diaphragm with central diaphragm apertures each, which form substantially two diaphragm planes parallel to each other, and comprise a plurality of transport channels closed toward the central region for transporting the bulk material from the first region to the second region of the rotatable drum through the central region, wherein the transport channels extend from the first to the second diaphragms at a non-90° angle relative to the two diaphragm planes.

Advantageously, the transport channels are arranged to be distributed evenly over the annular structure.

Advantageously, through flow apertures for the gaseous media are provided in the central region in the rotatable drum next to the respective transport channels which are closed toward the central region.

In a further embodiment of the present invention the central region is advantageously divided by a separating wall parallel to the diaphragm planes for the separate guiding of the drying air and the cooling air and merely the transport channels are exempt from the separating wall.

Advantageously, the first region of the drum is destined for drying or heating or reaction procedure and the second region of the drum is destined for cooling or further reaction procedure of the bulk material.

Advantageously, the first region and the second region of the drum are each provided with conveyor means causing a transport of the bulk material into the transport channels and, after the exit thereof from the transport channels, a transport of the bulk material in the second region until the discharge of the bulk material.

Advantageously, the central region is enclosed by a housing for discharging or supplying the gaseous media.

Advantageously, the housing comprises one or two exhaust ducts to the top and one or two fine material outlets at the bottom thereof.

Advantageously, the entire device may be inclined relative to the horizontal in the transport direction.

Advantageously, the angle of inclination ranges between 0.5° and 7°, preferably between 1 and 3°.

The method for drying or heating and cooling bulk material in accordance with the invention consists of the following steps which need not be performed in the indicated order, though:
introducing a moist or at least cold bulk material in a drying region;
rotating the drum with drying region, central region and cooling region;
introducing hot gases in the drying region;
drying and transporting the bulk material within the drying region to a central region;
transporting the dried, hot bulk material in transport channels closed toward the central region through the central region with exhaust apertures;
exit of the hot gas through the through flow apertures in the central region and via the housing and the connected exhaust duct;
transporting the dry, hot bulk material to the cooling region;
introducing cooling air and cooling the dry, hot bulk material in the coflow or counterflow procedure;
exhausting the heated cooling air;
discharging the dry, cooled bulk material.

Expediently, the method comprises the further step of: separating fine material in the central region, preferably by dropping caused by gravity.

Advantageously, the method according to the invention further comprises the step of: returning the exiting, heated cooling air flow to the drying region as preheated drying air for drying the cold and at least moist bulk material, and associated heat recovery and/or waste heat utilization from the cooler exhaust air.

Advantageously, the method for drying or heating and cooling of a moist or at least cold bulk material in accordance with the invention uses the device in accordance with the invention pursuant to the above description.

Alternatively, the drying or heating or reaction procedure in the first region takes place in accordance with the invention in the counterflow between gas and bulk material instead in the coflow.

Alternatively, the cooling or reaction procedure in the second region takes place in accordance with the invention in the coflow between gas and bulk material instead in the counterflow.

Expediently, in the following the first region will be referred to as drying zone and the second region will be referred to as cooling zone.

At the one end of the drum, i.e. at the side of the drying zone, via a housing and a short feed pipe, a hot gas generator is installed for supplying the hot gas required for drying. Likewise, at the other end of the drum, the cooling zone, a housing is positioned at which the dried and cooled solid matter may exit. The solid matter to be dried is inserted at one end of the drying-cooling drum and is dried in the drying zone of the dryer-cooler, wherein it moves in the direction of the middle of the drying-cooling drum.

At the end of the drying zone, i.e. in the central region, the suction housing for the consumed drying air and for the likewise consumed cooling exhaust air is positioned.

The cooling air (i.e. for example ambient air) is introduced in the cooling zone at the other end of the dryer/cooler and moves in the counterflow to the solid matter also in the direction of the suction housing for the consumed air which is positioned approximately in the middle of the entire drum.

For sucking the dryer exhaust air and the cooler exhaust air via the suction housing, the central region is provided with through flow apertures enabling an exit of the dryer exhaust air and the cooler exhaust air into the suction housing.

In order to avoid the falling-out of the dried and subsequently to be cooled solid matter through the through flow apertures of the central region and to transfer the solid matter instead from the drying zone to the cooling zone, the central region is designed in the manner in accordance with the invention.

The drying zone comprises at its end an annular weir designed as a diaphragm. In the middle of the diaphragm a preferably circular aperture is positioned through which the consumed dryer exhaust air may enter the central region at which the suction housing is arranged and through the through flow apertures of which the exhaust air may enter the suction housing and may be sucked off.

The dried solid matter accumulated at the annular weir is guided via tunnel-like transport channels from the drying zone through the region of the air sucking of the central region to the region of the cooling zone. The tunnel-like transport channels are closed at the top, at the bottom and at the sides and have thus no connection to the region of the air sucking and are each positioned between the sections in the drum wall for sucking off the dryer and cooler exhaust air. In order to achieve a transport of the solid matter through the tunnel-like transport channels, the transport channels may be arranged at an angle to the axis of the device according to the invention, so that the rotation of the device according to the invention exerts a conveying effect on the solid matter, similar as takes place by the guide vanes in the drying zone and in the cooling zone of the dryer/cooler.

The entry of the dried solid matter in the tunnel-like transport channels may be promoted by suitable conveying ledges upstream of the diaphragm. Expediently, the angle of inclination is between 0.5° and 7°, preferably between 1 and 3°.

In the case of an inclined design of the entire drying-cooling drum in which the transport of the solid matter takes place by the combination of rotation and inclination of the drum, an inclined arrangement of the tunnel-like transport channels relative to the axis of the drum may be waived under certain circumstances.

The sections in the drum wall are preferably designed in the same angle to the axis of the dryer/cooler as the tunnel-like transport channels and are thus each positioned between the tunnel-like transport channels. A different design of the sections in the drum wall, e.g. in the form of circular tubes, for achieving sufficient stability of the drum wall in this region is conceivable.

At the beginning of the cooling zone and/or at the end of the sucking zone a diaphragm similar to the weir downstream of the drying zone may be installed, said diaphragm preventing the solid matter transported through the tunnel-like transport channels into the cooling zone from returning into the region of sucking and from falling through the through flow apertures in the drum wall in the region of the sucking housing into the sucking housing.

In order to enable the passage of the consumed cooling air into the region of sucking, the diaphragm also comprises a central diaphragm aperture which is preferably positioned in the middle, e.g. in the form of a circular section. The consumed and heated cooler exhaust air flows through the diaphragm and is sucked off along with the exhaust air from the drying zone via the through flow aperture in the drum wall and via the sucking housing arranged in this region of the drum.

After the passage of the dried, hot solid matter through the tunnel-like transport channels in the region of the suction housing the solid matter is taken up by lift and guide vanes and is cooled in the cooling zone of the dryer/cooler. Due to the described preferred construction a counterflow between the solid matter and the cooling air is achieved in the cooling zone, by which measure a particular efficiency of the cooling is achieved.

The described solution does not have the disadvantage that the solid matter to be cooled gets into contact with hot walls of an inner drying drum. The cooling effect is thus maximized.

In a further embodiment of the present invention a separating wall is inserted in the central region between the two diaphragms for sucking off the drying air and sucking off the cooling air, said separating wall preventing the two exhaust streams from mixing with each other.

Moreover, respective separate sections for the separate sucking off of the drying air, on the one hand, and the cooling air, on the other hand, are introduced in the drum wall, as well as a likewise divided suction housing for the exhaust air is installed.

This design of the central region in connection with the divided suction housing enables the separate discharge of the two exhaust air streams and hence a variable further use of the two exhaust air streams, e.g. for returning the heated, still dry cooling air to the drying process or as a pre-heated combustion air for the hot gas generator. Such further use of the exhaust air streams has the advantage of distinctly improving the energy balance of the device in accordance with the invention.

Since the heated cooling air comprises a substantial portion of the heat previously being in the dried hot solid matter, the heat regained from the solid matter can be used for a particularly efficient operation of the dryer/cooler due to the design in accordance with the invention.

In a further embodiment of the divided central region and the divided suction housing the arrangement in accordance with the invention can also be used for sucking off the drying air, on the one hand, and, in distinction from the afore-described variant, for introducing the cooling air. The cooling air will then flow through the cooling zone in coflow with the dried solid matter to be cooled and will exit at the end of the drum at which the solid matter also exits.

In a further embodiment of the present invention the hot drying air may, instead at the front end of the drum at which the moist solid matter is introduced, also be fed via the divided housing and the divided central region. The drying air will then flow through the drying zone in counterflow to the moist solid matter to be dried, which may result in some practical cases in a particularly efficient drying of the solid matter. In order to avoid heat losses in the region of the drying zone, the latter may be provided with a thermotechnical insulation.

It may happen that fine-grained solid matter is entrained through the diaphragm apertures of the weirs due to the velocity of the air flow of both the drying air and the cooling air. If this solid matter is not conveyed subsequently along with the exhaust air via the sections in the drum wall and via the section housing e.g. to the downstream dust separating means, there exists the danger that this usually fine-grained solid matter falls down through the suction apertures and collects in the bottom part of the suction housing and causes problems in the course of the operation of the plant.

This solid matter may be discharged to the bottom via an aperture in the bottom region of the suction housing of the central region and a solid matter lock (e.g. a rotary air lock or a flap).

Two preferred embodiments of the present invention are illustrated in the Figures. There show:

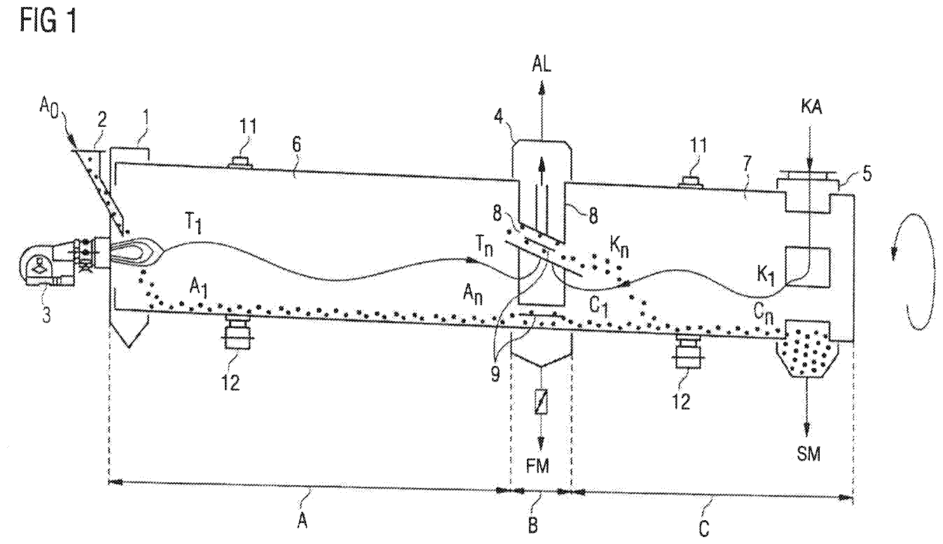

FIG. 1 a schematic section through a device in accordance with the invention with a “one-piece” central region;

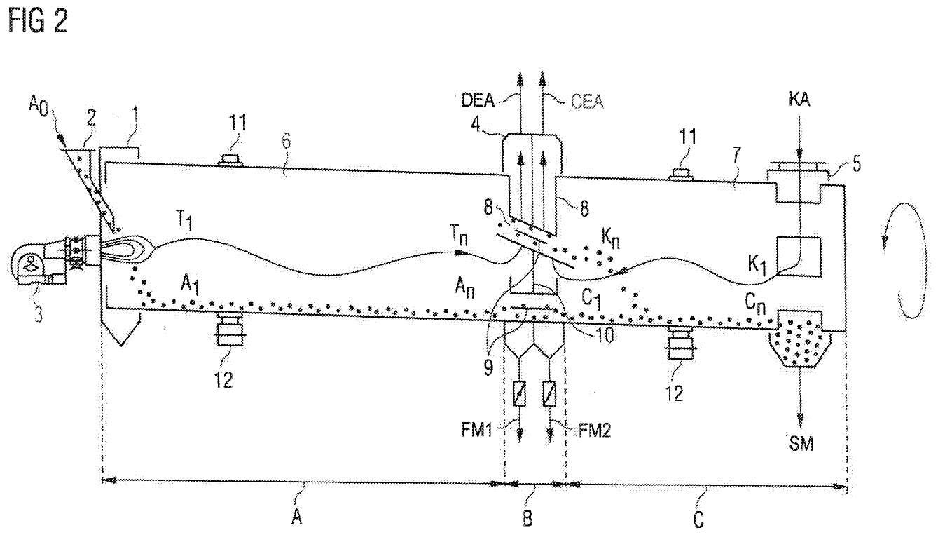

FIG. 2 a schematic section through a device in accordance with the invention with a “two-piece” central region;

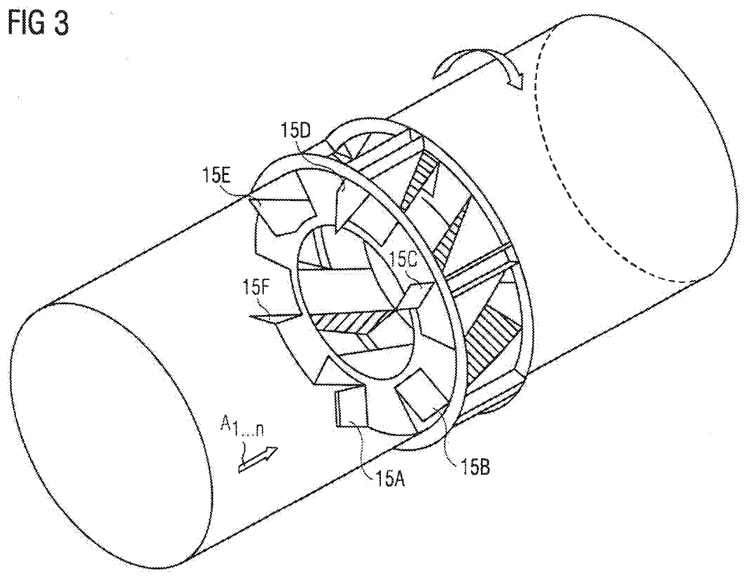

FIG. 3 a schematic perspective illustration of the central region according to FIG. 1;

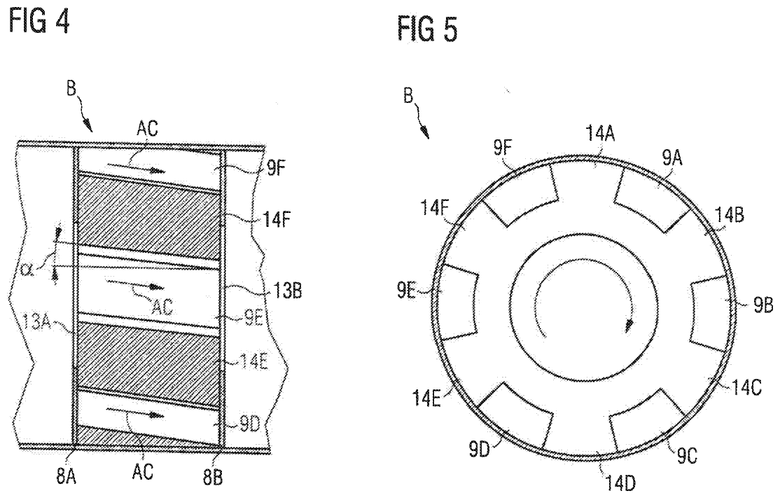

FIG. 4 a schematic side view of a central region in accordance with the invention;

FIG. 5 a schematic front view of a central region in accordance with the invention pursuant to FIG. 4.

FIG. 1 illustrates an embodiment of the device in accordance with the invention with an entry housing 1 at the left side. In its vicinity a device for the solid matter entry 2 is arranged through which the bulk material to be dried and to be cooled is introduced into the device in accordance with the invention. Likewise at the left 25 front side of the device in accordance with the invention a burner 3 is positioned which has the function of a conventional heating burner and sees to it that sufficient hot air is introduced into the device in accordance with the invention. As the case may be, the burner 3 comprises a combustion chamber for achieving a regular air entry temperature and for preventing the flame of the burner from burning overtly in the dryer. Pursuant to FIG. 1 the entry housing 1 is installed to be stationary and the drum of the device in accordance with the invention is mounted with the race 11 to rotate on the guide rollers 12. As a drive mechanism, a direct motor, a pinion with a gear, a sprocket or a chain drive may, for instance, be used. These technical solutions are known from the state of the art and have substantially the same effect and are exchangeable. They are not illustrated in FIG. 1 and FIG. 2.

When a particular amount of the bulk material is introduced in the entry housing 2, this amount has a particular temperature with a particular degree of moisture A₀. This amount passes in the drying zone 6 through different drying states from A₁ to Aₙ, wherein A₁ designates a rather moist state and Aₙ a state which is almost dry, but heated. Likewise, the temperature T₁ in the drying zone 6 changes from T₁ which designates a rather high temperature to Tₙ which designates a lower temperature.

The transport of the bulk material within the drying zone 6 of the drum may be performed by different technical measures. On the one hand, it is possible to carry out the transport within the drying zone 6 of the drum by conveying means available at the drum wall, for instance, in the form of guide vanes (not illustrated). Such conveying means have been known for a long time. It is likewise possible to incline the drum and to enable conveyance due to the angle of inclination. Basically, however, the use of guide vanes is to prefer since the mixing of the bulk material to be dried is of advantage and promotes drying.

As soon as the bulk material pursuant to FIG. 1 has reached the right edge of the drying zone 6, it will leave the region A and will enter the central region B in accordance with the invention. The central region B is confined on both sides by a diaphragm 8A, 8B. The central region B is passed by tunnel-like transport channels 9 through which the bulk material to be dried is conveyed from the drying zone 6 to the cooling zone 7. A preferred design of the central region B will be described in detail in FIGS. 3 to 5.

After leaving the drying zone 6 and/or the region A and the central region B, the bulk material should be substantially dry. As already shown schematically in FIG. 1, the drying zone 6 may be designed to be substantially longer than the cooling zone 7. In the cooling zone 7 and/or the region C the bulk material is cooled to a predetermined temperature and may leave the device in accordance with the invention as a dried, cooled material.

Pursuant to FIG. 1 drying takes place in coflow, i.e. the drying gas flow with the temperature T₁ to Tₙ proceeds in the same direction as the material flow A₁ to Aₙ. In the cooling zone 7 cooling takes place in counterflow, though, i.e. the material flow C₁ to Cₙ takes place contrary to the direction of flow of the cooling air (KA) K₁ to Kₙ. This favors cooling. In accordance with the invention, both the heated cooler exhaust air Kₙ and the moist dryer exhaust air Tₙ exit through the central region as exhaust air EA. For this purpose the central region B comprises, between the two diaphragms 8A and 8B, two central diaphragm apertures 13A and 13B (see FIG. 4) which enable the dryer exhaust air Tₙ and the cooler exhaust air Kₙ to first of all flow through these central diaphragm apertures 13A and 13B so as to subsequently leave the device in accordance with the invention through the through flow apertures 14A to 14F (see FIG. 5).

Dusts and particles carried along with the drying or cooling air into the central region are either carried along with the exhaust air EA and may be separated from the air in subsequent separators (exhaust filter or cyclones not illustrated), or they fall as fine material FM in the central region downward and through the respective bottom through flow apertures 14 into the housing 4. The dried and cooled solid matter SM is output as an end product at the right side of the device in accordance with the invention pursuant to FIG. 1.

FIG. 2 illustrates the same device in accordance with the invention as FIG. 1 apart from the difference that the central region B is of two-piece design, i.e. the drying zone 6 is separated from the cooling zone 7 by a separating wall 10. Due to the spatial separation of the two regions it is also necessary that the exhaust air discharge and the fine material discharge also take place separately and thus also two separating regions are available in the housing 4. The dryer exhaust air is, pursuant to FIG. 2, designated with DEA and the cooler exhaust air with CEA. The two fine material discharges are designated with FM1 and FM2. The dried and cooled solid matter SM is output as an end product at the right side of the device according to the invention pursuant to FIG. 2.

FIG. 3 illustrates a schematic representation of a central region B in accordance with the invention with a plurality of baffles 15A to 15F. The function of the baffles 15A to 15F consists in favoring and supporting the introduction of the bulk material from the drying zone 6 and/or A to the central region B. The baffles are preferably slightly inclined so as to enable trickling in into the tunnel-like channels 9A to 9F.

FIG. 4 and FIG. 5 illustrate a preferred embodiment of the central region B, but without baffles. FIG. 4 illustrates a schematic side view, wherein, however, the drum wall which covers the transport channels 9D, 9E and 9F is not shown. Pursuant to FIG. 5 six tunnel-like transport channels 9A to 9F and six through flow apertures 14A to 14F are provided. The tunnel-like transport channels 9A to 9F extend from the one diaphragm 8A to the other diaphragm 8B, but the tunnel-like transport channels 9A to 9F proceed under a non-90° angle α, preferably between 2° and 30°. Due to the non-90° angle α the technical effect is achieved that on clockwise rotation of the central region B the bulk material is conveyed into the tunnel-like transport channels 9A to 9F in the direction of the arrow AC and is there, comparable to a conveyor wheel, received in the drying zone 6 in the position 9D to 9F and is again discharged in the position 9A and 9B, but in the region of the cooling zone 7.

### LIST OF REFERENCE NUMBERS

1 entry housing
2 solid matter entry
3 burner
4 suction housing
5 exit housing
6 drying zone
7 cooling zone
8 diaphragm
9 tunnel-like transport channels
10 separating wall
11 race
12 guide rollers
13 diaphragm apertures
14 through flow apertures
15 baffles

1. A device for drying and/or heating and cooling bulk material, comprising:
a rotatable drum with means receiving the bulk material in a first region and means for discharging the bulk material from a second region,
wherein a central region is arranged between the first region and the second region, said central region consisting of an annular structure with a first diaphragm and a second diaphragm with central diaphragm apertures each, which form substantially two diaphragm planes parallel to each other, and comprise a plurality of transport channels closed toward the central region for transporting the bulk material from the first region to the second region of the rotatable drum, the transport channels extend from the first diaphragm to the second diaphragm at a non-90° angle α relative to the two diaphragm planes, and the central region is divided by a separating wall parallel to the diaphragm planes for the separate guiding of the drying air and the cooling air and merely the transport channels are exempt from the separating wall.

2. The device according to claim 1, wherein the transport channels are distributed evenly over the annular structure.

3. The device according to claim 1, wherein through flow apertures for the gaseous media are provided in the central region in the rotatable drum next to the respective transport channels.

4. The device of claim 1, wherein the first region of the drum is configured for drying or heating or reaction procedure and the second region of the drum is configured for cooling or further reaction procedure of the bulk material.

5. The device of claim 1, wherein the first region and the second region of the drum are each provided with conveyor means for causing a transport of the bulk material into the transport channels and, after the exit thereof from the transport channels, a transport of the bulk material in the second region until a discharge of the bulk material.

6. The device of claim 1, further comprising a housing enclosing the central region for discharging or supplying the gaseous media.

7. The device according to claim 6, wherein the housing further comprises an exhaust duct at a top portion of the housing and a fine material at a portion of the housing.

8. The device of claim 1, wherein the entire device is inclined relative to horizontal in a direction of transport of the bulk material.

9. The device according to claim 8, wherein an angle of inclination ranges between 0.5° and 7°.

10. A method for drying and/or heating and cooling bulk material, comprising the steps of:
introducing a cold and/or moist bulk material in a drying region;
rotating the drying region;
introducing hot gases in the drying region;
drying and transporting the bulk material within the drying region to a central region;
transporting the dried, hot bulk material in transport channels closed toward the central region through the central region with apertures for the supplying and/or or discharging of gas;
entering and/or existing of the hot gas through the through flow apertures in the central region and via the housing and the connected exhaust duct, wherein the central region is divided by a separating wall parallel to the diaphragm planes for the separate guiding of the drying air and the cooling air and merely the transport channels are exempt from the separating wall;
transporting the dry, hot bulk material to the cooling region;
introducing cooling air and cooling the dry, hot bulk material in a coflow or counterflow procedure;
exhausting the heated cooling air; and
discharging the dry, cooled bulk material.

11. The method according to claim 10, further comprising the step of:
separating fine material in the central region, preferably by dropping caused by gravity.

12. The method of claim 10, further comprising the step of:
returning the exiting, heated cooling air flow to the drying region as preheated drying air for drying the cold and at least moist bulk material, and associated heat recovery and/or waste heat utilization from the cooler exhaust air.

13. The method of claim 10, further comprising the step of:
for drying and/or heating and cooling the bulk material, using a device comprising:
a rotatable drum with means for receiving the bulk material in a first region and means for discharging the bulk material from a second region,
wherein a central region is arranged between the first region and the second region, said central region consisting of an annular structure with a first diaphragm and a second diaphragm with central diaphragm apertures each, which form substantially two diaphragm planes parallel to each other, and comprise a plurality of transport channels closed toward the central region for transporting the bulk material from the first region to the second region of the rotatable drum, the transport channels extend from the first diaphragm to the second diaphragm at a non-90° angle α relative to the two diaphragm planes, and the central region is divided by a separating wall parallel to the diaphragm planes for the separate guiding of the drying air and the poling air and merely the transport channels are exempt from the separating wall.

14. The method according to claim 10, wherein the drying or heating or reaction procedure in the first region takes place in the counterflow between gas and bulk material instead of in the coflow.

15. The method according to claim 10, wherein the cooling or reaction procedure in the second region takes place in the coflow between gas and bulk material instead of in the counterflow.

16. The method of claim 11, wherein the separating of fine material is by dropping caused by gravity.

17. The device according to claim 8, wherein an angle of inclination ranges between 1° and 3°.
